(19) United States
(12) Patent Application Publication
(10) Pub. No.: US 2026/0067585 A1
(43) Pub. Date: Mar. 5, 2026

(54) CONTROL APPARATUS THAT CONTROLS MULTIPLE IMAGING DEVICES, CONTROL METHOD, STORAGE MEDIUM, AND SYSTEM

(71) Applicant: CANON KABUSHIKI KAISHA, Tokyo (JP)

(72) Inventor: NAO ASANO, Tokyo (JP)

(21) Appl. No.: 19/311,577

(22) Filed: Aug. 27, 2025

(30) Foreign Application Priority Data
Sep. 2, 2024 (JP) 2024-150537

(51) Int. Cl. H04N 23/90; H04N 23/63; H04N 23/661; H04N 23/695

(52) U.S. Cl. CPC H04N 23/90; H04N 23/632; H04N 23/633; H04N 23/661; H04N 23/695

(57) ABSTRACT

A control apparatus remotely controls multiple imaging devices that are connected to the control apparatus via a network and includes an acquisition unit for acquiring LV images from the multiple imaging devices, a display unit for displaying the acquired LV images, an operation unit for receiving a touch operation, and a processor executing a program stored in memory to transmit movement instruction information about an AF frame for which first coordinate information corresponding to a position at which a first LV image is touched is specified to a first imaging device associated with the first LV image in a case where the first LV image that is displayed on the display unit is touched, and transmit movement instruction information about an AF frame for which second coordinate information based on the first coordinate information is specified to a second imaging device that differs from the first imaging device.

### BACKGROUND

### Field of the Technology

The present disclosure relates to a control apparatus, a control method, a storage medium, and a system.

### Description of the Related Art

In recent years, multiple digital cameras have been used for photographing in event venues such as wedding or concert venues and conference venues such as press conference venues in order to take photographs with optimal compositions with certainty. However, simultaneous photographing with the multiple digital cameras requires multiple cameramen and accordingly results in large personnel expenses and other costs and challenges.

A cameraman cannot take a photograph, for example, at a location at which entry is limited.

In view of this, in such a scenario, a control apparatus that is connected to multiple cameras via a network controls the cameras in a known system (Japanese Patent Laid-Open No. 2023-9896). For example, multiple digital cameras are installed at various locations in a venue, and a few photographers remotely connect a control apparatus represented by a tablet or a laptop computer to the digital cameras via a network. A system that is capable of collectively taking photographs with the multiple digital cameras by operating the control apparatus is used. In some specific examples, an existing technique, such as “NX Field” (trademark name), made by Nikon, or “Remote Camera Tool” (trademark name), made by Sony, is used as a remote photographing system that is capable of controlling remote photographing with multiple digital cameras.

As for still image photographing with a digital camera, a photographer refers to a live view image displayed on a screen of the digital camera and a display (referred to below as an “AF frame”) corresponding to a region in which a signal for focus detection regarding auto focus (AF) in an imaging region of the digital camera is acquired. The photographer operates the digital camera and moves the AF frame so as to follow the movement of an object. Subsequently, the object is automatically focused, and a photograph is taken.

As for still image photographing with a remote photographing system in which a single control apparatus remotely controls multiple digital cameras, the control apparatus receives live view images from the multiple digital cameras and displays the live view images side-by-side on a screen.

The photographer transmits, from the control apparatus to each digital camera, an instruction for moving the AF frame from the current coordinates to coordinates on a live view corresponding to the position of a touch operation, for example, by touching a screen of the control apparatus in a live view image display region for each digital camera. This enables movement of the AF frame of each digital camera to freely determined coordinates on the live view image to be controlled.

Suppose that the AF frames of the multiple digital cameras that are connected to the control apparatus are moved by using a technique in a comparative example so as to follow an object. In this case, there is a problem in that it is necessary to touch the screen of the control apparatus in the live view image display region for each digital camera a number of times equal to the number of the digital cameras, and the photographer needs extra time and effort. In addition, there is a risk that the preparation for photographing by the photographer is delayed during this operation, and consequently, the photographer misses a photo opportunity.

### SUMMARY

According to an aspect of the present disclosure, there is provided a control apparatus that remotely controls multiple imaging devices that are connected to the control apparatus via a network and that includes: an acquisition unit configured to acquire live-view (LV) images from the multiple imaging devices; a display unit configured to display the LV images that are acquired by the acquisition unit; an operation unit configured to receive a touch operation performed by a user; at least one memory storing a program; and at least one processor that, upon execution of the stored program, is configured to: transmit movement instruction information about an autofocus (AF) frame for which first coordinate information corresponding to a position at which a first LV image is touched is specified to a first imaging device associated with the first LV image in a case where the first LV image that is displayed on the display unit is touched; and transmit movement instruction information about an AF frame for which second coordinate information based on the first coordinate information is specified to a second imaging device that differs from the first imaging device.

Features of the present disclosure will become apparent from the following description of embodiments with reference to the attached drawings. The following description of embodiments is described by way of example.

### BRIEF DESCRIPTION OF THE DRAWINGS

FIG. 1A is a hardware configuration diagram illustrating the structure of a digital camera. FIG. 1B and FIG. 1C are an example of the appearance of the digital camera.

FIG. 2 is a hardware configuration diagram illustrating the structure of a control apparatus.

FIG. 3 illustrates multiple digital cameras and the control apparatus and is a system configuration diagram illustrating remote control with the control apparatus and the multiple digital cameras connected to each other with a network device interposed therebetween.

FIG. 4A and FIG. 4B illustrate an example of a scene in which multi-remote photographing is performed by a photographer in a press conference venue.

FIG. 5A to FIG. 5G illustrate examples of portions of a screen displayed on a display unit of a control apparatus when three digital cameras and the control apparatus are connected to each other via a network, and multi-remote photographing is performed with live view images from the three digital cameras that are displayed on the display unit of the control apparatus.

FIG. 6A, FIG. 6B, and FIG. 6C illustrate flowcharts of processes of controlling AF frame movement performed by a control apparatus on multiple digital cameras that are connected to the control apparatus via a network during multi-remote photographing according to a first embodiment.

FIG. 7 illustrates an example of a screen for settings related to controlling linked movement of digital cameras by a control apparatus.

FIG. 8 illustrates a flowchart of a process of controlling AF frame movement performed by digital cameras that receive an instruction from a connected control apparatus according to the first embodiment.

FIG. 9 illustrates a flowchart of a process of controlling AF frame movement performed by a control apparatus on multiple digital cameras that are connected to the control apparatus via a network during multi-remote photographing according to a second embodiment.

FIG. 10 illustrates a flowchart of a process of controlling AF frame movement performed by digital cameras that receive an instruction from a connected control apparatus according to a third embodiment.

FIG. 11 illustrates a flowchart of a process of controlling AF frame movement performed by a control apparatus on multiple digital cameras that are connected to the control apparatus via a network during multi-remote photographing according to the third embodiment.

### DESCRIPTION OF THE EMBODIMENTS

Embodiments for carrying out the present disclosure will hereinafter be described in detail with reference to the attached drawings.

The embodiments described later are examples for carrying out the present disclosure and may be appropriately amended or modified depending on various conditions and the structure of a device to which the present disclosure is applied. The embodiments can be appropriately combined.

### First Embodiment

### Structure of Digital Camera 100

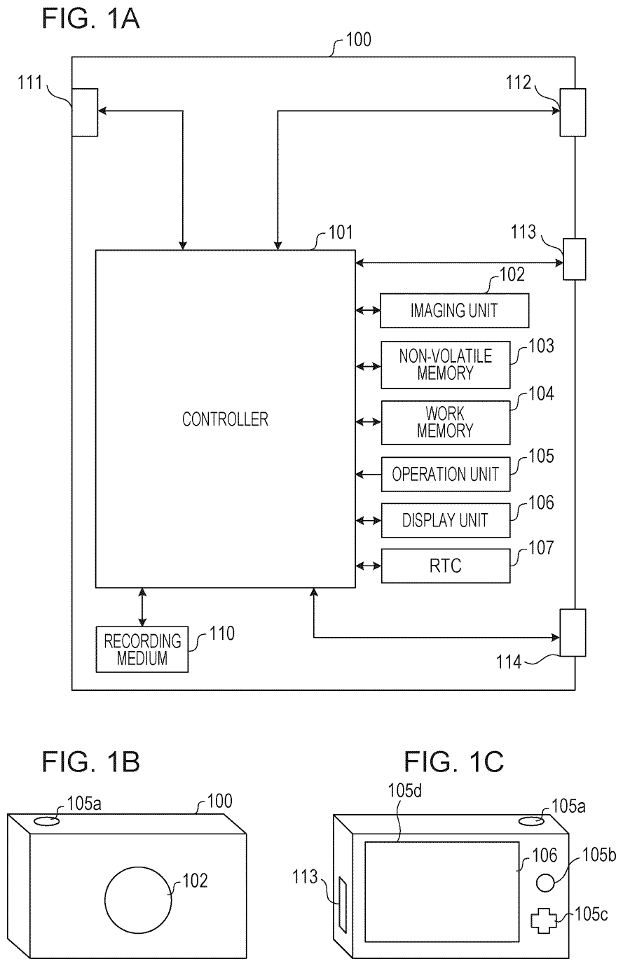

FIG. 1A is a hardware configuration diagram illustrating an example of the structure of a digital camera 100 that is an example of a communication device according to the present embodiment. The digital camera is described herein as an example of the communication device, but the communication device is not limited thereto. For example, the communication device may be an information processing apparatus such as a mobile media player, a so-called tablet device, or a personal computer.

A controller 101 controls components of the digital camera 100 in accordance with an input signal or a program described later. The entire device may be controlled by multiple pieces of hardware that share processing instead of the controller 101 that controls the entire device.

For example, an imaging unit 102 includes an optical system that controls an optical lens unit, an aperture stop, a zoom, and focus and an imaging element for converting light (video) that is introduced via the optical lens unit into an electrical video signal. A complementary metal oxide semiconductor (CMOS) or a charge-coupled device (CCD) is typically used as the imaging element. The controller 101 controls the imaging unit 102. The imaging element consequently converts object light after image formation by a lens that is included in the imaging unit 102 into an electric signal and outputs digital data as image data, for example, after a noise reduction process. As for the digital camera 100 according to the present embodiment, the image data is recorded in a recording medium 110 in accordance with the standard of design rule for a camera file system (DCF).

A non-volatile memory 103 is an electrically erasable and recordable non-volatile memory and stores, for example, a program that is executed by the controller 101, as described later.

A work memory 104 is used, for example, as a buffer memory that temporarily stores the image data that is imaged by the imaging unit 102, an image display memory of a display unit 106, or a work area of the controller 101.

An operation unit 105 is used to receive an instruction for the digital camera 100 from a user. For example, the operation unit 105 includes a power supply button for the user to instruct the power supply of the digital camera 100 to be turned on or off, a release switch for instructing photographing, and a play button for instructing the image data to be played. In addition, an operation member such as a dedicated connection button for starting communication with an external apparatus via a communication unit 111 described later is included. A touch screen that is formed on the display unit 106 described later is also included in the operation unit 105.

The release switch includes an SW1 and an SW2. When the release switch is half pushed, the SW1 is turned on. Consequently, an instruction for performing an operation of preparing photographing such as an autofocus (AF) process, an auto exposure (AE) process, an auto white balance (AWB) process, or a pre-flashing (EF) process described later is received. When the release switch is fully pushed, the SW2 is turned on. Consequently, an instruction for photographing is received.

The operation unit 105 also includes an AF-ON button for performing only the AF process described later that is included in the operation of preparing photographing. When the AF-ON button is pushed, the controller 101 outputs an instruction for starting an AF operation, and the AF process starts.

The AF process includes autofocus detection of a region (referred to below as a “focus detection region”) of the imaging element of the imaging unit 102 in which a signal for focus detection is acquired. An object can be focused in a manner in which a focus lens that is included in a photographic lens is moved to a focus position depending on a defocus amount that is detected in the focus detection region.

A user operation via the operation unit 105 enables the controller 101 to instruct a change in the position of a region (referred to below as an “AF frame”) corresponding to the focus detection region indicated on a viewfinder screen that is displayed on the display unit 106 described later. The display region of the AF frame corresponds to the focus detection region, and the focus detection region is changed when the display region of the AF frame is changed. As an example of an operation of changing the position of the AF frame, when a touch screen of the operation unit 105 is operated, the position of the AF frame is changed (moved) to the position resulting from the operation, but the present disclosure is not limited thereto.

A user operation via the operation unit 105 enables an AF frame selection mode to be selected and set among multiple AF frame selection modes including at least two described below.
Single point AF . . . Mode in which the user sets an AF frame at a single point that is freely selected. The focus detection is performed in the focus detection region corresponding to the set AF frame.
Multi-point AF . . . Mode in which the user sets AF frames at multiple points. For example, multiple AF frames are classified into multiple zones, and the user specifies any one of the zones, based on the position of a touch, and sets multiple AF frames within the specified zone (referred to below as “zone AF”). As for multi-point AF including zone AF, the controller 101 subsequently performs automatic selection of the multiple AF frames as described below. In automatic selection, an AF frame to be focused among the multiple AF frames that are set by the user is selected based on automatic selection conditions, and the focus detection is performed using the selected AF frame. The automatic selection conditions include conditions such as the position of an object on the screen, an object size, or an object distance, although the AF frame is basically selected such that a nearest object is focused. Various determination methods can be used, but the present disclosure is not limited thereto.

The display unit 106 displays a viewfinder image, the AF frame during photographing, the image data after photographing, and characters for an interactive operation. The display unit 106 is not necessarily contained in the digital camera 100. The digital camera 100 can be connected to an internal or external display unit 106 and has at least a function of controlling the display of the display unit 106.

A real-time clock (RTC) 107 manages a clock. The user may set a clock time by using the operation unit 105, by acquiring time information via the communication unit 111, or by using a radio clock, provided that the time can be managed.

The recording medium 110 can record the image data that is output from the imaging unit 102.

The recording medium 110 may be attachable to and detachable from the digital camera 100 or may be contained within the digital camera 100. That is, the digital camera 100 includes at least a unit that accesses the recording medium 110.

The communication unit 111 is an interface for connection to an external device. The digital camera 100 according to the present embodiment can transmit and receive data to and from the external device via the communication unit 111. For example, the image data that is generated by the imaging unit 102 can be transmitted to the external device via the communication unit 111. According to the present embodiment, the communication unit 111 includes an interface conforming to the IEEE 802.11 standard for communication with the external device via a wireless LAN. The controller 101 controls the communication unit 111 for wireless communication with the external device. The communication method is not limited to a wireless LAN, and examples thereof include an infrared communication method.

The communication unit 111 is an example of a first wireless communication unit.

A communication unit 112 is an interface for connection to an external device. The digital camera 100 according to the present embodiment can transmit and receive data to and from the external device via the communication unit 112. For example, the image data that is generated by the imaging unit 102 can be transmitted to the external device via the communication unit 112. According to the present embodiment, the communication unit 112 includes an interface conforming to the IEEE 802.15.1 standard for Bluetooth (registered trademark) communication with the external device. The controller 101 controls the communication unit 112 for wireless communication with the external device. The communication method is not limited to Bluetooth (registered trademark), and examples thereof include a wireless LAN conforming to the IEEE 802.11 standard or an infrared communication method. The communication unit 112 is an example of a second wireless communication unit.

A communication unit 113 is an interface for connection to an external device. The digital camera 100 according to the present embodiment can transmit and receive data to and from the external device via the communication unit 113. For example, the image data that is generated by the imaging unit 102 can be transmitted to the external device via the communication unit 113. According to the present embodiment, the communication unit 113 includes an interface conforming to the IEEE 802.3 standard for communication with the external device via a wired LAN (Ethernet). The controller 101 controls the communication unit 113 for communication with the external device. The communication method is not limited to a wired LAN, and examples thereof include a USB communication method. The communication unit 113 is an example of a wired communication unit.

The communication unit 112 of the digital camera 100 according to the present embodiment has a peripheral mode or a central mode. When the communication unit 112 operates in the peripheral mode, the digital camera 100 according to the present embodiment can operate as a client device in accordance with Bluetooth (registered trademark). In the case where the digital camera 100 operates as the client device, connection with an external device operating in the central mode enables communication. As for authentication of the external device to be connected, unique information about the external device to be connected is stored in the non-volatile memory 103 after a previous pairing. In the case where power is supplied to a Bluetooth (registered trademark) module, the digital camera 100 can transmit signals even with the state of a power supply being off.

For example, a close proximity wireless communication unit 114 includes a wireless communication antenna, modulation and demodulation circuits for processing a wireless signal, and a communication controller. The close proximity wireless communication unit 114 outputs a modulated wireless signal from the antenna. The close proximity wireless communication unit 114 demodulates a wireless signal that is received by the antenna for contactless close proximity communication conforming to the ISO/IEC 18092 standard (so-called near field communication (NFC)). The close proximity wireless communication unit 114 according to the present embodiment is disposed on a side portion of the digital camera 100.

The close proximity wireless communication unit 114 and a close proximity wireless communication unit 214 are in close proximity to each other, communication consequently starts, and a control apparatus 200 described later is connected. In a case where the control apparatus 200 is connected by using the close proximity wireless communication unit 114, the close proximity wireless communication unit 114 and the close proximity wireless communication unit 214 are not necessarily brought into contact with each other. The close proximity wireless communication unit 114 and the close proximity wireless communication unit 214 enable communication even if spaced a certain distance apart, and accordingly, these approach each other within a range that enables close proximity wireless communication for connecting the control apparatus 200. Approaching within the range that enables close proximity wireless communication is also described as close proximity.

The appearance of the digital camera 100 will now be described. FIG. 1B and FIG. 1C illustrate an example of the appearance of the digital camera 100. A release switch 105a, a play button 105b, a directional key 105c, and a touch screen 105d are operation members that are included in the operation unit 105 described above. An image acquired by imaging with the imaging unit 102 is displayed on the display unit 106. The communication unit 113 is a wired LAN or USB interface.

In some cases below, it is described that the digital camera 100 performs a process, but, in practice, the controller 101 reads a program that is stored in the non-volatile memory 103 and loaded into the work memory 104 and performs various processes according to the program instructions.

The digital camera 100 is described above.

### Structure of Control Apparatus 200

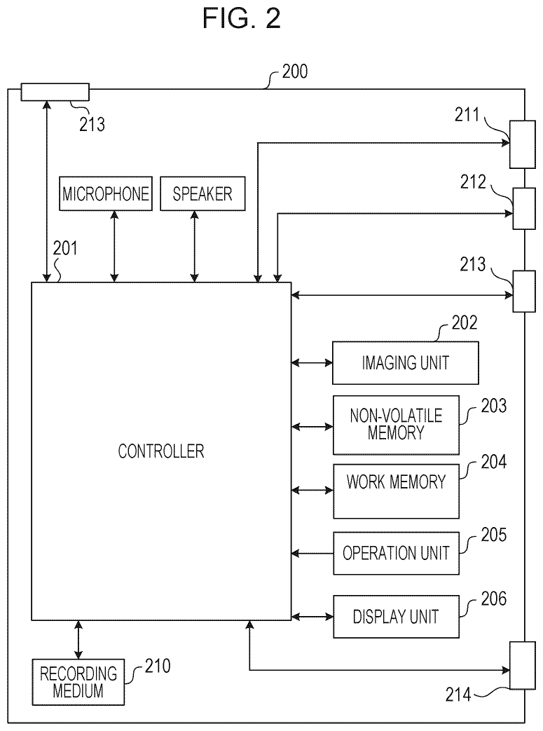

FIG. 2 is a hardware configuration diagram illustrating an example of the structure of the control apparatus 200 that is an example of an information processing apparatus according to the present embodiment. The control apparatus will be described as an example of the information processing apparatus, but the information processing apparatus is not limited thereto. For example, the information processing apparatus may be a digital camera that has a wireless function, a smartphone, a tablet device, or a personal computer.

A controller 201 controls components of the control apparatus 200 in accordance with an input signal or a program described later. The entire apparatus may be controlled by multiple pieces of hardware that share processing instead of the controller 201 that controls the entire apparatus.

A non-volatile memory 203 is an electrically erasable and recordable non-volatile memory. An operating system (OS) that is basic software executed by the controller 201 and an application that fulfills an applied function in cooperation with the OS are recorded in the non-volatile memory 203. According to the present embodiment, an application for communicating with the digital camera 100 is stored in the non-volatile memory 203.

A work memory 204 is used, for example, as an image display memory of a display unit 206 or a work area of the controller 201.

An operation unit 205 is used to receive an instruction for the control apparatus 200 from the user. For example, the operation unit 205 includes a power supply button for the user to instruct the power supply of the control apparatus 200 to be turned on or off, an operation member that sets an RTC, and an operation member such as a touch screen that is formed on the display unit 206.

The controller 201 can detect operations described below (referred to below as “touch operations”) on the touch screen that is included in the operation unit 205. An operation of touching the touch screen with a finger or a pen is referred to below as touch on. An operation of bringing the finger or the pen into contact with the touch screen when the finger or the pen was not already in contact with the touch screen is referred to below as touch down. An operation of moving the finger or the pen with the finger or the pen being in contact with the touch screen is referred to below as touch move. An operation of separating the finger or the pen that is in contact with the touch screen from the touch screen is referred to below as touch up. A state in which neither a finger nor a pen touches the touch screen is referred to below as touch off. These operations and the coordinates at which the finger or the pen are in contact with the touch screen are reported to the controller 201, and the controller 201 determines the operation performed on the touch screen, based on the reported information. As for movement, a vertical component and a horizontal component of the direction in which the finger or the pen moves on the touch screen can be detected based on changes in the coordinates. In the case of constant movement on the touch screen between a touch down and a touch up, a stroke is drawn. An operation of quickly drawing a stroke is referred to as a flick. The flick is the operation of quickly moving a finger a certain distance with the finger being in contact with the touch screen and then releasing the finger, in other words, an operation of quickly touching the touch screen with a flicking finger. When a certain distance or more of movement at a predetermined speed or more is detected followed by detection of a touch up, it can be determined that a flick has occurred. In a case where a certain distance or more of movement at less than a predetermined speed is detected, it can be determined that dragging has occurred. The touch screen may be any one of various touch screens such as a resistive touch screen, a capacitive touch screen, a surface acoustic wave touch screen, an infrared touch screen, an electromagnetic induction touch screen, an image recognition touch screen, or an optical sensor touch screen.

The display unit 206 displays the image data or characters for an interactive operation. The display unit 206 is not necessarily included within the control apparatus 200. The control apparatus 200 can be connected to an internal or external display unit 206 and has at least a function of controlling the display of the display unit 206.

The RTC manages a clock. The user may set a clock time by using the operation unit 205, by acquiring time information via a communication unit 211, a communication unit 212, or a public network connection unit 213, or by using a radio clock, provided that the time can be managed. The time may be acquired by a detection mechanism from a mechanical mechanism such as an analog clock (in such a case, the RTC includes the detection mechanism).

A recording medium 210 can record the image data that is transferred from the digital camera 100 to the controller 201 via the communication unit 211. The recording medium 210 may be attachable to and detachable from the control apparatus 200 or may be contained within the control apparatus 200. That is, the control apparatus 200 includes at least a unit that accesses the recording medium 210.

The communication unit 211 is an interface for connection to an external device. The control apparatus 200 according to the present embodiment can transmit and receive data to and from the external device via the communication unit 211. According to the present embodiment, the communication unit 211 includes an antenna, and the controller 201 can be connected to the digital camera 100 with the antenna interposed therebetween. According to the present embodiment, the communication unit 211 includes an interface conforming to the IEEE 802.11 standard for communication with the external device via a wireless LAN. The controller 201 controls the communication unit 211 for wireless communication with the external device. The communication method is not limited to a wireless LAN, and examples thereof include an infrared communication method. The communication unit 211 is an example of the first wireless communication unit.

The communication unit 212 is an interface for connection to an external device. The control apparatus 200 according to the present embodiment can transmit and receive data to and from the external device via the communication unit 212. For example, the image data that is generated by the digital camera 100 can be received via the communication unit 212. According to the present embodiment, the communication unit 212 includes an interface conforming to the IEEE 802.15.1 standard for communication with the external device via so-called Bluetooth (registered trademark). The controller 201 controls the communication unit 212 for wireless communication with the external device. The communication method is not limited to Bluetooth (registered trademark), and examples thereof include a wireless LAN conforming to the IEEE 802.11 standard or an infrared communication method. The communication unit 212 is an example of the second wireless communication unit.

A communication unit 213 is an interface for connection to an external device. The control apparatus 200 according to the present embodiment can transmit and receive data to and from the external device via the communication unit 213. For example, the image data that is generated by an imaging unit 202 can be transmitted to the external device via the communication unit 213. According to the present embodiment, the communication unit 213 is an interface conforming to the IEEE 802.3 standard for communication with the external device via a wired LAN (Ethernet). The controller 201 controls the communication unit 213 for communication with the external device. The communication method is not limited to a wired LAN, and examples thereof include a USB communication method. The communication unit 213 is an example of a wired communication unit.

The communication unit 212 of the control apparatus 200 according to the present embodiment has a peripheral mode or a central mode. When the communication unit 212 operates in the central mode, the control apparatus 200 according to the present embodiment can operate as a server device in accordance with Bluetooth (registered trademark). In the case where the control apparatus 200 operates as the server device, connection with an external device operating in the peripheral mode enables communication. As for authentication of the external device to be connected, unique information about the external device to be connected is stored in the non-volatile memory 203 after a previous pairing.

For example, the close proximity wireless communication unit 214 includes a wireless communication antenna, modulation and demodulation circuits for processing a wireless signal, and a communication controller. The close proximity wireless communication unit 214 outputs a modulated wireless signal from the antenna. The close proximity wireless communication unit 214 demodulates a wireless signal that is received by the antenna for contactless close proximity communication conforming to the ISO/IEC 18092 standard (so-called near field communication (NFC)). The close proximity wireless communication unit 214 according to the present embodiment is disposed on a side portion of the control apparatus 200.

In some cases below, it is described that the control apparatus 200 performs a process. However, in practice, the controller 201 reads an application (such as an application function, an OS, or a service of the OS) program that is stored in the non-volatile memory 203 and loaded into the work memory 204 and performs various processes according to the application program instructions.

### Structure of System

A system configuration diagram according to the present embodiment will now be described.

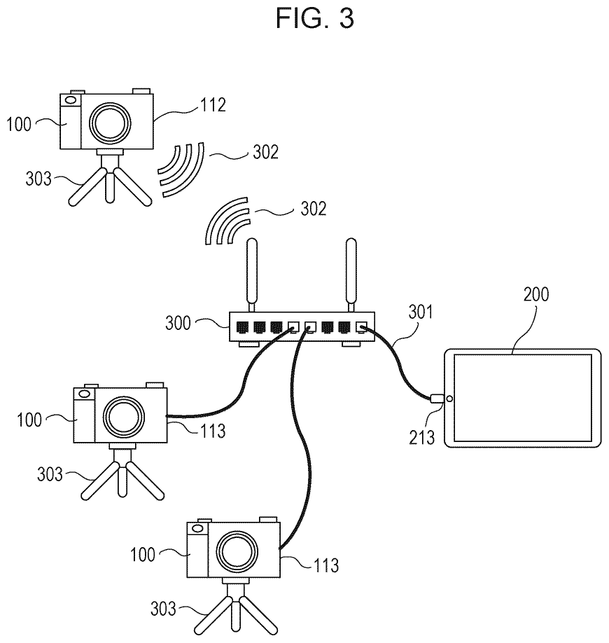

FIG. 3 illustrates multiple digital cameras 100 and the control apparatus 200 and is a system configuration diagram illustrating remote control with the control apparatus 200 and the multiple digital cameras 100 connected to each other with a network device 300 interposed therebetween.

The digital cameras 100 are mounted on tripods 303 and installed at photographing positions. In this example, the digital cameras 100 are installed on the tripods 303 but may be installed on remote heads that can be remotely controlled regarding panning, tilting, and zooming control.

In some cases, the digital camera 100 wirelessly communicates with the control apparatus 200 via the communication unit 112 using wireless radio waves 302 that are relayed through the network device 300. In some cases, communication with the control apparatus 200 is established via the communication unit 113 and the network device 300 using wired LAN cables 301.

In some cases, the control apparatus 200 wirelessly communicates with the digital cameras 100 via the communication unit 212 using wireless radio waves 302 that are relayed through the network device 300. In some cases, communication with the digital cameras 100 is established via the communication unit 213 and the network device 300 using wired LAN cables 301.

In this example, communication is established via the network device 300, but each digital camera 100 and the control apparatus 200 may be directly connected to each other.

As illustrated in FIG. 3, with the multiple, installed digital cameras 100 and the control apparatus 200 being communicable with each other, the control apparatus 200 can acquire information about the settings of each digital camera 100 and can instruct each digital camera 100 to change its settings.

In particular, the control apparatus 200 transmits an instruction for each digital camera 100 to move its AF frame to specified coordinates (referred to below as an “instruction on AF frame movement”). The movement of the AF frame of the digital camera 100 can be controlled (referred to below as “control of AF frame movement”). The digital camera 100 changes the position of the AF frame not only in response to the instruction from the controller 101 via the operation unit 105 described above but also in response to the instruction on AF frame movement that is received from the control apparatus 200.

In addition, photographing can be remotely instructed in a manner in which an instruction on photographing and an instruction on activating or deactivating focus drive are transmitted.

With this structure, the control apparatus 200 can control photographing with the multiple digital cameras 100 (referred to below as “multi-remote photographing”). Multi-Remote Photographing in Event such as Press Conference

The following description contains an object composition and a photographing state during multi-remote photographing with the multiple digital cameras 100 that are installed in a venue as an example of photographing in a press conference venue according to the present embodiment.

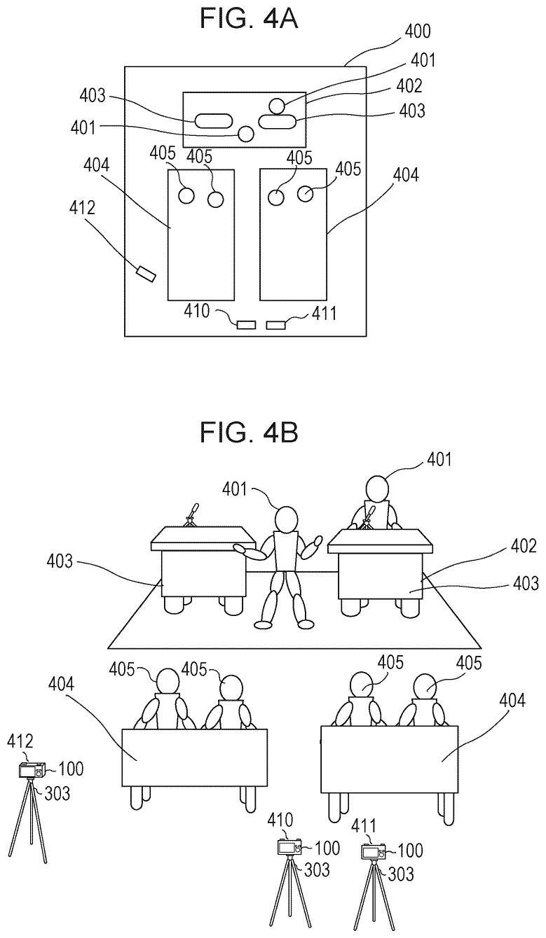

FIG. 4A and FIG. 4B illustrate a scene in which the multiple digital cameras 100 are installed for multi-remote photographing in a press conference venue.

As illustrated in FIG. 4A, speakers 401 mainly sit at positions near lecterns 403 of a platform 402 and make a speech or speak dialogue in a scene in which the number of the speakers 401 that are objects is 2 in a press conference venue 400. However, the positions on the platform 402 are frequently changed. For example, FIG. 4A illustrates an example in which one of the speakers 401 leaves the lectern 403 and moves to the center of the platform 402 for photographing. In another example, it is thought that the speakers 401 communicate with each other, for example, shake hands or give an award or a document.

As illustrated in FIG. 4B, in the case where the scene in the press conference venue 400 is photographed, arrangement is determined such that a good photograph that is the most stable can be expected. For example, the composition is such that the two speakers 401 are viewed from the front, and a first digital camera 410 is disposed behind reporter seats 404 on which the press corps sit.

In some cases, however, the first digital camera 410 misses a decisive moment, for example, because press corps 405 on the reporter seats 404 move and are captured by the camera and cover the object. In these cases, a second digital camera 411 is disposed next to the first digital camera 410 with the composition such that the two speakers 401 are viewed substantially from the front in order to always take a photograph with certainty. The first digital camera 410 and the second digital camera 411 are separated from the speakers 401 at similar angles and distances, and accordingly, the compositions are similar to each other, but a decisive moment can be captured with more certainty.

In many cases, the speakers 401 change the directions of their faces and bodies into a left or right direction so as to face a reporter who asks a question when answering the question from the press corps who sit on the reporter seats 404. In these cases, the speakers 401 are preferably photographed at angles for photographing with a better composition. For this reason, a third digital camera 412 is disposed on the left of the reporter seats 404 on which the press corps 405 sit with the composition such that the two speakers 401 are viewed at angles from the left. According to the present embodiment, the arrangement is limited to the left of the reporter seats 404, but in the case where the number of the digital cameras is increased, one or more digital cameras 100 are additionally disposed on the right in the same manner.

A control screen for the multi-remote photographing that is proposed will now be described.

### Control Screen for Multi-Remote Photographing

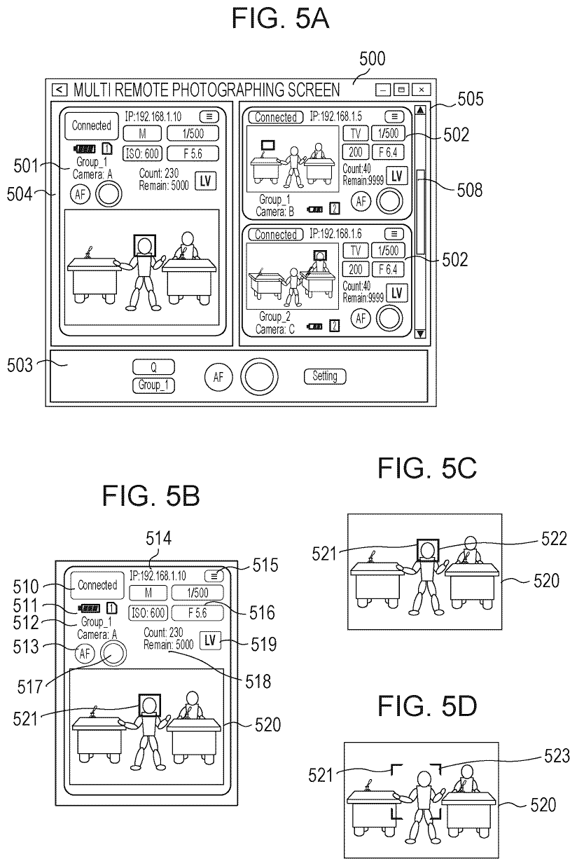

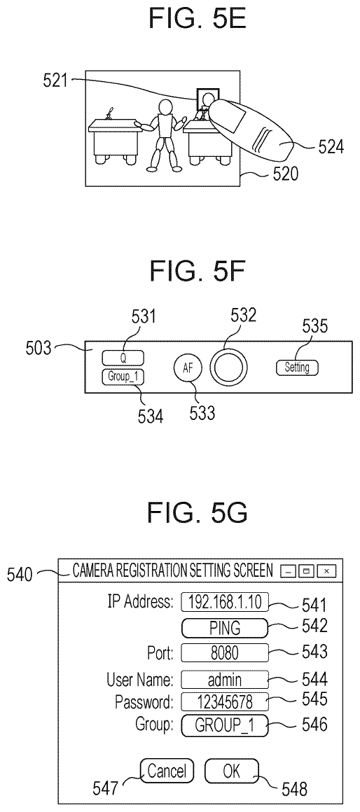

FIG. 5A to FIG. 5G illustrate the structure of a screen for multi-remote photographing with three digital cameras 100 and the control apparatus 200 connected to each other.

FIG. 5A illustrates a multi-remote photographing screen 500 of the control apparatus 200 that is connected to the digital cameras 100.

On the multi-remote photographing screen 500, a camera control member 501 that configures settings related to photographing and that controls a focus instruction, photographing, and so on of a first digital camera 100 from the control apparatus 200 is displayed. In addition, camera control members 502 that control the second and third digital cameras 100 that are connected to the control apparatus 200 are displayed. In addition, a multi-camera control member 503 that collectively controls the multiple digital cameras 100 is displayed (control of multiple cameras is referred to below as “multi-camera control”).

When the settings of connection with the digital cameras 100 are registered in the control apparatus 200, the first camera control member 501 is added to a main camera display member 504, and the second and additional camera control members 502 are added to a sub-camera display member 505. The first camera control member 501 that is added to the main camera display member 504 and the second and additional camera control members 502 that are added to the sub-camera display member 505 have different sizes and arrangements. In particular, live view display operation members 520, described later, are displayed in the first camera control member 501 in a large size and displayed in the second and additional camera control members 502 in a smaller size than in the first camera control member 501. However, the first camera control member 501 and the second and additional camera control members 502 have the same function. In the case where the number of digital cameras to be connected is large, and all the camera control members 502 cannot be contained in the sub-camera display member 505 at the same time, the camera control members 502 that are not displayed on the screen can be displayed by scrolling with a scroll member 508.

In the case of the multi-remote photographing in the press conference venue 400 illustrated in FIG. 4A and FIG. 4B, the first digital camera 410 that can be expected to take a good photograph that is the most stable is added to the main camera display member 504. The second digital camera 411 and the third digital camera 412 are added to the sub-camera display member 505. The digital camera 100 corresponding to the first camera control member 501 that is added to the main camera display member 504 is referred to below as a “main camera.” The digital cameras 100 corresponding to the second and additional camera control members 502 that are added to the sub-camera display member 505 are collectively referred to as “sub-cameras”.

### Structure of Camera Control Member

FIG. 5B illustrates the structure of the camera control member 501.

The camera control member 501 includes an operation member 510 that controls the state of the connection with the digital camera 100, a display member 511 that displays the state of a power supply of the digital camera 100 and the state of a recording member, and a name display member 512 for identifying the camera and a photographing group. In addition, an operation member 513 that controls autofocus of the digital camera 100, a display member 514 that displays the network address of the digital camera 100, and a setting member 515 for camera control settings are included. In addition, a member group 516 that controls the display and change of the photographing settings of the digital camera 100, and an operation member 517 for remote photographing by the digital camera 100 are included. In addition, a display member 518 that displays the remaining photograph number and a photograph number of the digital camera 100 and a live view display control member 519 of the digital camera 100 are included. In addition, the live view display operation member 520 that displays a live view image (also referred to as a LV image) of the digital camera 100 and an AF frame display member 521 that displays the AF frame of the digital camera 100 are included.

The display of the AF frame display member 521 is superimposed on the live view display operation member 520. This enables the form of the display of the live view display operation member 520 and the AF frame display member 521 to be similar to the display of the live view image of the display unit 106 and the AF frame during photographing with the digital camera 100.

The AF frame display member 521 changes the form of the display of the AF frame depending on the current AF frame selection mode of the digital camera 100. In the case where the AF frame selection mode is single point AF, as illustrated in FIG. 5C, the AF frame display member 521 displays the AF frame at a single point that is set by the user as a rectangular frame 522. In the case of multi-point AF, the AF frame display member 521 displays visually recognized AF frames at multiple points that are selected by the user. For example, in the case of zone AF, as illustrated in FIG. 5D, a zone that contains AF frames at multiple points is displayed as a region 523 with its corners marked so as to be visually recognized. Another display method that can be used in the case of multi-point AF is to display multiple, selected AF frames using multiple rectangular frames, but the present disclosure is not limited thereto.

The user implements the control of AF frame movement of the digital camera that is displayed by the AF frame display member 521 by operating the live view display operation member 520. For example, as illustrated in FIG. 5E, the control apparatus 200 transmits an instruction on AF frame movement when a touch operation of a finger 524 of the user on the live view display operation member 520 is detected. Specifically, the digital camera 100 corresponding to the camera control member 501 or 502 of the live view display operation member 520 that detects the touch operation calculates coordinates in a coordinate system on the live view image corresponding to a position at which the touch operation is detected. The instruction on AF frame movement is transmitted. Subsequently, the digital camera 100 changes the position of the AF frame in response to the instruction on AF frame movement that is received from the control apparatus 200. Consequently, the AF frame that is displayed by the AF frame display member 521 of the control apparatus 200 moves to the position at which the user performs the touch operation.

The aspects of the display operation member for the multi-remote photographing in this example are described by way of example and may be appropriately amended or modified.

### Structure of Multi-Camera Control Member

FIG. 5F illustrates the structure of the multi-camera control member 503.

The multi-camera control member 503 includes a member that collectively instructs the multiple digital cameras 100. Specifically, the multi-camera control member 503 includes an operation member 531 that collectively sets and controls photographing parameter settings and an operation member 532 that controls the multi-remote photographing. In addition, an operation member 533 that collectively controls autofocus of the multiple digital cameras 100 and an operation member 534 that selects and displays the group of digital cameras to which instructions are transmitted by using the operation members 531, 532, and 533 described above are included. In addition, an operation member 535 that has a function of starting up a screen on which various other settings for the multiple digital cameras 100 are displayed is included.

### Camera Registration Setting Screen

FIG. 5G illustrates a camera registration setting screen 540 on which registration settings for each digital camera 100 are displayed.

The camera registration setting screen 540 includes an operation member 541 that sets the IP Address of each digital camera 100 and an operation member 542 that checks whether the digital camera 100 is connected to the network in a manner in which the control apparatus 200 executes a PING command. In addition, an operation member 543 that sets a port number of the digital camera 100, a username setting operation member 544 for logging into the digital camera 100, and a password setting operation member 545 are included. In addition, an operation member 546 that sets a group to which the digital camera 100 belongs, an operation member 547 that cancels the settings, and an operation member 548 that determines the settings are included.

The control screen for the multi-remote photographing is described above.

### Problem for System

A system according to the present embodiment controls movement of the AF frames of the multiple digital cameras 100 to which the control apparatus 200 is connected, but in this case, there is a problem in that an operation that takes time and effort is needed.

In the example of the press conference venue 400 in FIG. 4A and FIG. 4B described above, the speakers 401 who sit near the lecterns 403 leave the lecterns 403 and move to the center of the platform 402. The positions of the AF frames of the multiple digital cameras 100 that are installed are set at positions near the lecterns 403 in the live view image for photographing in order for a photographer to take a photograph in which speakers 401 are objects. In this case, the AF frames of the multiple digital cameras 100 are to be immediately moved to positions near the faces of the speakers 401 who move to the center of the platform 402 when the speakers 401 move as described above.

However, the system according to the present embodiment needs to repeat the touch operation multiple times in order to control the movement of the AF frames of the multiple digital cameras 100. Specifically, the touch operation on the live view display operation member 520 of the camera control member 501 or 502 of the control apparatus 200 needs to be repeatedly performed a number of times equal to the number of digital cameras 100. For this reason, the photographer needs extra time and effort. In addition, there is a risk that the photographer delays the preparation for photographing during this operation, and consequently, the photographer misses a photo opportunity.

### Features of Control Apparatus 200 According to Present Disclosure

In view of this, according to the present embodiment, control of the movement of the AF frames of the multiple digital cameras 100 to which the control apparatus 200 is connected is devised.

The case where the control apparatus 200 detects the touch operation on the live view display operation member 520 of the camera control member 501 or 502 will be described. In this case, the control apparatus 200 specifies coordinates on the live view image corresponding to the position at which the touch operation is detected and transmits the instruction on AF frame movement (also referred to as movement instruction information) to the first digital camera 100 corresponding to the live view display operation member 520 that detects the touch operation. In addition, destination coordinates are calculated and specified based on the destination coordinates of the first digital camera 100, and the instruction on AF frame movement is transmitted to a freely determined number of one or more digital cameras 100 among the second and additional digital cameras 100 that are connected to the control apparatus 200. The destination coordinates of the first digital camera 100 are an example of first coordinate information. The destination coordinates (that is, the destination coordinates of the freely determined number of one or more digital cameras 100 among the second and additional digital cameras 100) that are calculated based on the destination coordinates of the first digital camera 100 are an example of second coordinate information.

This enables the user to control the movement of the AF frames of the multiple digital cameras 100 by collectively performing the touch operation.

The operation of the control apparatus 200 and each digital camera 100 according to the first embodiment to solve the problem will be described below.

### Series of Operation of Control Apparatus 200 According to First Embodiment

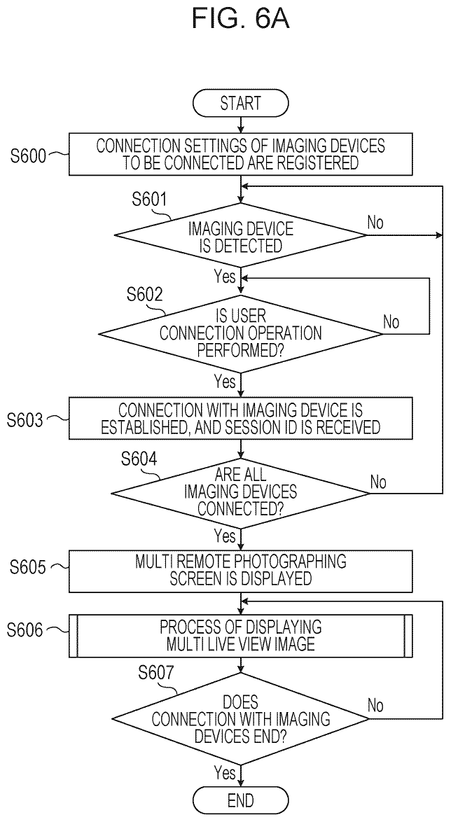

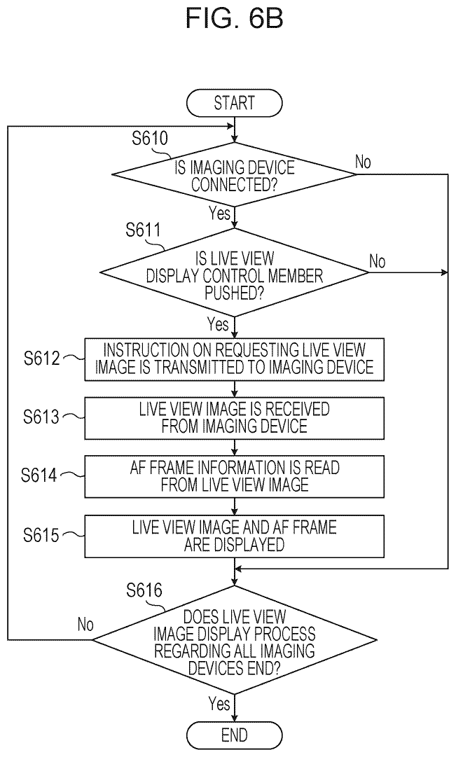

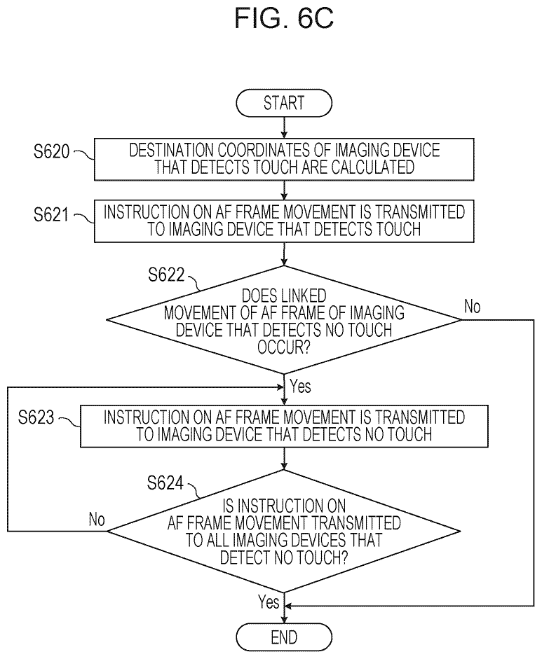

FIG. 6A, FIG. 6B, and FIG. 6C illustrate an example of operation processing that is performed by the control apparatus 200 during multi-remote photographing with the multiple digital cameras 100 according to the present embodiment. The operation processing described herein includes displaying the live view images of the multiple digital cameras 100 on the multi-remote photographing screen. In addition, an operation of controlling the movement of the AF frames of the multiple digital cameras 100 is included.

FIG. 6A illustrates a series of operations from establishment of the connection between the control apparatus 200 and the multiple digital cameras 100 to an end.

The series of operations starts when the control apparatus 200 starts up.

At S600, the control apparatus 200 registers the connection settings of the multiple digital cameras 100 to be connected and then performs a process at S601.

At S601, the control apparatus 200 performs a process of detecting the digital cameras 100, determines whether a digital camera 100 is detected, and then performs a process at S602 if a digital camera 100 is detected or repeats the process at S601 if a digital camera 100 is not detected.

At S602, the control apparatus 200 determines whether a user connection operation is performed, and then performs a process at S603 if it is determined that a connection is requested or repeats the process at S602 if no connection is requested.

At S603, the control apparatus 200 performs a process of establishing a connection with the digital camera 100 that is detected, and then performs a process at S604.

At S604, it is determined whether the second and additional digital cameras 100 that are registered for connection at S600 are connected, and whether multi-remote photographing can start. If it is determined that all registered digital cameras 100 are connected and that multi-remote photographing can start, a process at S605 is performed. If it is determined that all registered digital cameras 100 are not connected and that one or more digital cameras 100 remain to be connected, the process at S601 is performed again.

At S605, the multi-remote photographing screen is displayed, and then a process at S606 is performed.

At S606, the control apparatus 200 performs a process of displaying a multi-live view image depicting, for example, the scene illustrated in FIG. 4B, and then a process at S607 is performed.

At S607, whether the connection with the multiple digital cameras 100 ends and the user ends the multi-remote photographing is determined. If it is determined that these end, the series of operations end. If it is determined that these do not end, the process at step S606 is performed again.

FIG. 6B illustrates a series of operations of the process of displaying the multi-live view image that is performed by the control apparatus 200 on the multiple digital cameras 100 at S606 in FIG. 6A. The control apparatus 200 starts the series of operations after displaying the multi-remote photographing screen at S605.

At S610, whether a digital camera 100 that is registered in the control apparatus 200 is connected is determined. If it is determined that it is connected, a process at S611 is performed. If it is determined that it is not connected, it is not necessary for the live view image to be displayed on the multi-remote photographing screen, and accordingly, a process at S616 is performed.

At S611, whether the live view display control member 519 is pushed is checked. If it is pushed, a process at S612 is performed. If it is not pushed, it is not necessary for the live view image to be displayed on the multi-remote photographing screen, and accordingly, the process at S616 is performed.

At S612, an instruction on requesting the live view image is transmitted to the digital camera 100 (referred to below as an instruction on a live view image request), and then a process at S613 is performed.

At S613, the live view image is received from the digital camera 100, and then a process at S614 is performed.

At S614, AF frame information described later is read from additional information in the live view image that is received from the digital camera 100. Subsequently, a process at S615 is performed.

At S615, the live view image that is received from the digital camera 100 at S613 is displayed on the live view display operation member 520, and the AF frame is displayed on the AF frame display member 521, based on the AF frame information that is read at S614. Subsequently, a process at S616 is performed.

At S616, whether a live view image display process described for S610 to S615 regarding all of the digital cameras 100 that are displayed on the multi-remote photographing screen 500 ends is determined. If it is determined that the live view image display process regarding all of the multiple digital cameras 100 ends, the series of operations ends. If it is determined that the live view image display process regarding all of the multiple digital cameras 100 does not end, the process at S610 is performed again.

FIG. 6C illustrates a series of processing operations that are performed by the control apparatus 200 when the control apparatus 200 controls the movement of the AF frames regarding the multiple digital cameras 100. The series of operations starts when a touch operation on a predetermined member that displays the live view image in the process of displaying the multi-live view image in FIG. 6A is detected on the multi-remote photographing screen 500 in FIG. 5A. The predetermined member described herein is the live view display operation member 520 of the camera control member 501 of the main camera or one of the live view display operation members 520 of the camera control members 502 of the sub-cameras. The digital camera 100 corresponding to the live view display operation member 520 that detects the touch operation is referred to as an “operating camera,” and the other digital cameras 100 corresponding to the other live view display operation members 520 are referred to as “non-operating cameras.”

At S620, when a touch operation is detected on the live view display operation member 520 regarding the operating camera, the control apparatus 200 calculates coordinates in a coordinate system of the live view image, which are the destination coordinates of the AF frame corresponding to the position at which the touch operation is detected on the live view display operation member 520. The position at which the touch operation is detected on the live view display operation member 520 corresponds to the coordinates in an X-axis direction and a Y-axis direction on the live view display operation member 520. The destination coordinates of the AF frame are simply referred to below as the “destination coordinates” in some cases.

At S621, the control apparatus 200 transmits the instruction on AF frame movement for instructing the AF frame of the operating camera to be moved to the destination coordinates that are calculated at S620, and then a process at S622 is performed.

At S622, the control apparatus 200 determines, based on a predetermined condition, whether movement of the AF frames of the non-operating cameras is controlled (referred to below as “control of AF frame linked movement”) based on the touch operation on the operating camera. The predetermined condition for the determination at S622 may be determined by an application program that is loaded to the work memory 204 of the control apparatus 200. The predetermined condition may be stored as a variable that can be set by the user in any manner in the non-volatile memory 203, the work memory 204, or the recording medium 210. Examples of the predetermined condition may include a fixed condition that is always true, that is, always performing the AF frame linked movement and a condition that changes depending on various application settings or a combination thereof.

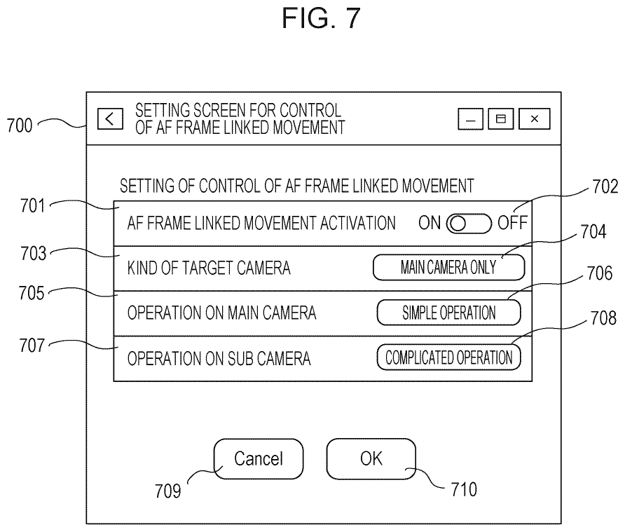

According to the present embodiment, the determination is made depending on a condition based on settings that are set by the user on a setting screen for the control of AF frame linked movement. The setting screen for the control of AF frame linked movement will now be described with reference to FIG. 7.

### Setting Screen for Control of AF Frame Linked Movement

FIG. 7 illustrates the structure of a screen on which the predetermined condition for determining whether the control of AF frame linked movement at S622 in FIG. 6C is implemented is set. When the operation member 535 of the multi-camera control member 503 illustrated in FIG. 5F is operated, a setting screen 700 for the control of AF frame linked movement is displayed.

The setting screen 700 for the control of AF frame linked movement includes an AF frame linked movement activation setting area 701 for setting the activation of the control of AF frame linked movement and an AF frame linked movement activation selection member 702 that selects whether the AF frame linked movement is activated.

In the case where the AF frame linked movement activation selection member 702 is set so as to represent activation, various conditions are considered as additional conditions for the determination at S622. For example, an AF frame linked movement target camera setting area 703 for setting the kind of operating camera that causes the control of AF frame linked movement to be implemented is included. An AF frame linked movement target camera selection member 704 that selects the kind of operating camera that causes the AF frame linked movement to occur is included. According to the present embodiment, a method of selecting the kind of operating camera is for the user to select the kind from among “all cameras (the main camera and the sub-cameras),” the “main camera only,” or the “sub-cameras only,” but the selecting method is not limited thereto.

In addition, an operation member for setting the kind of operation for causing the AF frame linked movement to occur for every kind of camera that is selected by the AF frame linked movement target camera selection member 704 is included.

An AF frame linked movement operation setting area 705 for the main camera and an AF frame linked movement operation selection member 706 for the main camera that set the kind of operation for causing the AF frame linked movement to occur in the case where the operating camera is the main camera are included. An AF frame linked movement operation setting area 707 for the sub-cameras and an AF frame linked movement operation selection member 708 for the sub-cameras that set the kind of operation for causing the AF frame linked movement to occur in the case where the operating camera is one of the sub-cameras are included.

According to the present embodiment, a method of selecting the kind of operation enables the user to select a “simple operation” or a “complicated operation.” The definitions of the “simple operation” and the “complicated operation” will be described. For example, in the case of a short tap in which a time from the touch down to the touch up is shorter than a predetermined time when the control apparatus 200 detects the touch operation, it may be determined that the kind of operation is the “simple operation.” In the case of a long tap in which a time from the touch down to the touch up is longer than a predetermined time when the control apparatus 200 detects the touch operation, it may be determined that the kind of operation is the “complicated operation.” Alternatively, it may be determined that the kind of operation is the “simple operation” if the number of fingers or pens that touch the touch screen during the touch operation, that is, the number of points on the touch screen when the control apparatus 200 detects the touch operation, is 1, and that the kind of operation is the “complicated operation” if the number is 2 or more. It may be determined that the kind of operation is the “simple operation” in the case of a single tap in which the number of touch downs when the control apparatus 200 detects the touch operation is 1, and that the kind of operation is the “complicated operation” in the case of a double tap in which the number is 2.

The definitions of the “simple operation” and the “complicated operation” are thus determined in various ways, but the present disclosure is not limited thereto. A method of selecting the kind of operation for causing the AF frame linked movement to occur is not limited to the method of using the “simple operation” or the “complicated operation.”

In addition, an operation member 709 that cancels the settings on the setting screen 700 for the control of AF frame linked movement and an operation member 710 that determines the settings are included. When the operation member 710 that determines the settings is operated, the control apparatus 200 records the settings that are selected by each selection member on the setting screen 700 for the control of AF frame linked movement described above.

The description of the series of operations illustrated in FIG. 6C will now be continued.

At S622, whether the AF frame linked movement of a digital camera that does not detect a touch occurs is determined. Specifically, the determination is made depending on a condition based on the settings of the setting screen for the control of AF frame linked movement illustrated in FIG. 7. A first condition is that the AF frame linked movement activation selection member 702 is set to activation. A second condition is that the kind of the current operating camera is included in the kind of camera that is selected by the AF frame linked movement target camera selection member 704. A third condition is that the kind of touch operation at the beginning of this series of operations is an operating method that is selected by the AF frame linked movement operation selection member 706 or 708.

When all of the first through third conditions are satisfied, a process at S623 is performed for the control of AF frame linked movement.

When at least any one of the conditions is not satisfied, AF frame linked movement is not needed, and accordingly, the series of processing ends.

At S623, the control apparatus 200 transmits the instruction on AF frame movement for instructing AF frames of non-operating cameras to be moved to the same coordinates as the destination coordinates that are calculated at S620, and then a process at S624 is performed.

In a case where the live view images of the operating camera and each non-operating camera have different sizes and different aspect ratios, a conversion process may be performed. Information about the sizes and aspect ratios of the live view images is an example of size information. Specifically, coordinates acquired by converting the coordinate system of the live view image of the operating camera into the coordinate system of the live view image of each non-operating camera through scaling conversion or aspect conversion are used so as to be equal to the destination coordinates of the operating camera.

At S624, whether the control of AF frame linked movement illustrated in S623 regarding all of the non-operating cameras ends is determined. If it is determined that it ends, the series of operations ends. If it is determined that it does not end, and the control of AF frame linked movement regarding some non-operating cameras does not end, the process at S623 is performed again.

The processing described above is the series of processing operations performed by the control apparatus 200 when the control apparatus 200 controls the movement of AF frames regarding multiple digital cameras 100 according to the first embodiment.

In the processing according to the embodiment described above, the control of AF frame linked movement is implemented regarding all of the non-operating cameras under the control of AF frame linked movement. However, the control of AF frame linked movement may be implemented regarding only one or more non-operating cameras that belong to the same group as the main camera. That is, whether the name of the group that is displayed by the name display member 512 of the operating camera at S623 in FIG. 6C is the same as the name of the group that is displayed by the name display member 512 of each non-operating camera may be determined. Therefore, at S623, the instruction on AF frame movement may be transmitted only to non-operating cameras belonging to the same group as the operating camera, and in the case of different groups, the instruction on AF frame movement may not be transmitted, and the process at S624 may then be performed.

### Series of Processing of Digital Camera 100 According to First Embodiment

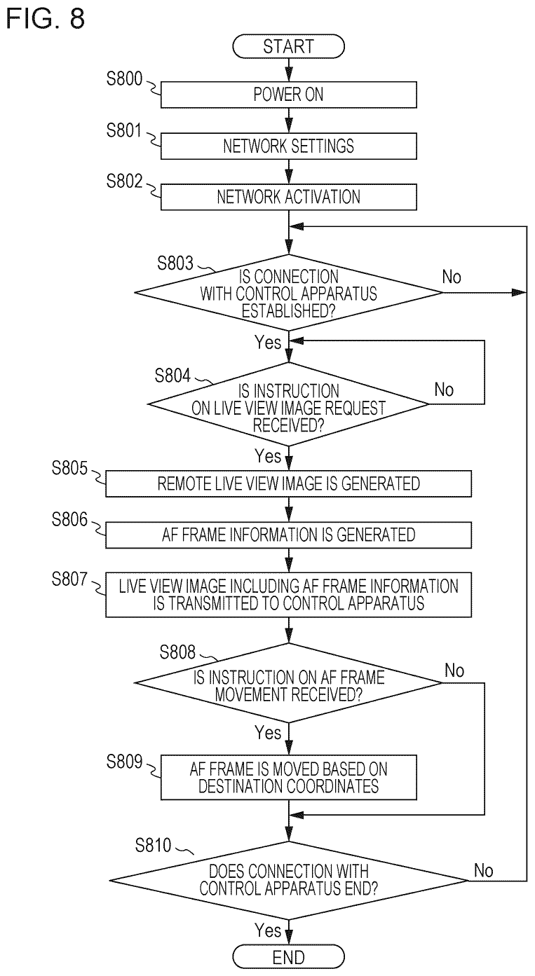

FIG. 8 illustrates an example of operation processing that is performed by the multiple digital cameras 100 that receive an instruction from the control apparatus 200 during multi-remote photographing according to the present embodiment. The operation processing described herein includes a process of displaying the live view images of the multiple digital cameras 100 on the multi-remote photographing screen. In addition, operation processing when the movement of the AF frames of the multiple digital cameras 100 is controlled is included.

FIG. 8 illustrates a series of operations from establishment of connections between the digital cameras 100 and the control apparatus 200 to an end. The series of operations start when the digital cameras 100 are disposed at the photographing positions.

At S800, the user turns on the power supply of each digital camera 100, the digital camera 100 starts up such that photographing can start, and then a process at step S801 is performed.

At S801, network settings for connection with the control apparatus 200 are configured, and then a process at S802 is performed.

At S802, the network settings are activated, the digital cameras 100 wait for connection with the control apparatus 200, and then a process at S803 is performed.

At S803, whether the control apparatus 200 requests connection is determined. If it is determined that connection is requested, the connection process is performed. Subsequently, whether connection with the control apparatus 200 is established is determined. If it is determined that connection with the control apparatus 200 is not established, the process at S803 is repeated, and the request for connection from the control apparatus 200 is checked. If it is determined that connection with the control apparatus 200 is established, a process at S804 is performed.

At S804, the digital camera 100 determines whether an instruction on live view image request is received from the control apparatus 200. If it is determined that an instruction on live view image request is received, a process at S805 is performed. If it is determined that an instruction on live view image request is not received, the process at S804 is repeated, and the instruction on live view image request from the control apparatus 200 is checked again.

At S805, the digital camera 100 performs a process of generating a live view image from the image data that is imaged by the imaging unit 102 and that is stored in the work memory 104, and then a process at S806 is performed.

At S806, the digital camera 100 generates AF frame information as additional information related to the live view image.

The AF frame information is information about display of the AF frame when the AF frame information is superimposed on the live view image and is displayed. Examples of the AF frame information according to the present embodiment include information (position and size information) that represents at least the position and size of the AF frame and that is represented by, for example, X-axis and Y-axis coordinates in the coordinate system of the live view image. In addition, information (focus and defocus information) that represents whether the object is focused and information that represents the current AF frame selection mode, for example, may be included.

At S807, the digital camera 100 transmits the live view image that is generated at S805 and the additional information including the AF frame information that is generated at S806 to the control apparatus 200. The control apparatus 200 receives the AF frame information and the live view image from the digital camera 100 and superimposes the AF frame on the live view image for display by a live view display operation member 520 and a AF frame display member 521. This enables an image to be displayed on the multi-remote photographing screen 500 of the control apparatus 200 in a similar manner to the AF frame and the live view image on the display unit 106 during photographing with the digital camera 100, and the operability of the user during remote photographing can be improved.

At S808, whether the instruction on AF frame movement is received from the control apparatus 200 is determined. If it is determined that an instruction on AF frame movement is received, a process at S809 is performed. If it is determined that an instruction on AF frame movement is not received, a process at S810 is performed.

At S809, the destination coordinates that are specified by the instruction on AF frame movement that is received from the control apparatus 200 at S808 are read, and the AF frame is moved to the destination coordinates. Consequently, the controller 101 instructs the position of the AF frame on the viewfinder screen that is displayed on the display unit 106 to be changed as in the user operation via the operation unit 105. The position of the AF frame that is displayed corresponds to the focus detection region as described above, and accordingly, the focus detection region is changed when the position of the AF frame is changed.

At S810, the digital camera 100 determines whether the connection that is established at S803 with the control apparatus 200 ends. If the connection ends, the series of operations end. If the connection does not end, the process at S803 is performed again. In the case where the AF frame is moved at S809, the process at S803 is performed again depending on the determination at S810. Subsequently, the live view image and the AF frame information are transmitted to the control apparatus 200 again at S807 after the AF frame is moved. In this case, the AF frame information can be transmitted to the control apparatus 200 after the AF frame movement at S809.

The processing described above is an example of the series of processing operations performed by the multiple digital cameras 100 connected to the control apparatus 200 during multi-remote photographing according to the first embodiment described above.

In the method described according to the embodiment described above, the AF frames regarding only the non-operating cameras are moved under the control of AF frame linked movement. However, not only are the AF frames regarding the non-operating cameras moved, but also in a case where the AF frames in the AF frame selection mode of the non-operating cameras are narrow, the AF frame selection mode may be changed into an AF frame selection mode in which a wider AF frame is specified as additional control. For example, whether the current AF frame selection mode of the digital cameras 100 is single point AF may be determined after the instruction on AF frame movement is transmitted to the non-operating cameras at S623 in FIG. 6C. In the case of single point AF, the control apparatus 200 transmits an instruction on changing the AF frame selection mode to multi-point AF to the digital cameras 100. In the case where the process of changing the AF frame selection mode of the non-operating cameras is additionally performed, and consequently, the operating camera and the non-operating cameras have slightly different angles of view, that is, even in the case where the position of the object on the live view image of each non-operating camera slightly differs from the position of the object on the live view image of the operating camera, the object can be captured in the AF frame region of the non-operating camera under the control of AF frame linked movement.

As for the control of AF frame linked movement, a process of emphasis display in a display form that differs from the display form of the operating camera may be additionally performed when the AF frames of the non-operating cameras are moved. For example, a method can be used to cause the AF frames after movement to blink for a certain time regarding only the non-operating cameras when the AF frame display members 521 display the AF frames at S615 in FIG. 6B after the control of AF frame linked movement in FIG. 6C. In addition, the AF frames before movement may be displayed for the certain time so as to be distinguishable from the AF frames after movement by using, for example, a different color. The process of emphasis display brings an advantage to make the movement of the AF frames of the non-operating cameras that differ from the operating camera easy to visually recognize by the user.

### Second Embodiment

In the method according to the first embodiment described above, the AF frames of the operating camera and the non-operating cameras are moved to the same coordinates on the live view images under the control of AF frame linked movement.

For this reason, for example, it can be expected that each non-operating camera can capture the object in the AF frame region under the control of AF frame linked movement among the digital cameras 100 in the press conference venue 400 in FIG. 4A and FIG. 4B such that, for each of the digital cameras 100, the angles and the distances from the object and the compositions are similar to each other. In this example, the first digital camera 410 serves as the operating camera, and the second digital camera 411 serves as the non-operating camera.

However, the third digital camera 412 and the first digital camera 410 have different angles and distances from the object. In the case where the digital camera 100 that has a different composition is the non-operating camera, there is a possibility that the non-operating camera cannot be expected to capture the object in the AF frame region.

In view of this, according to a second embodiment, the control apparatus 200 may detect the object in a region near the position of the AF frame on the live view image of the operating camera when the AF frame of the operating camera is moved by performing an object detection process. A structure described below moves the AF frame of each non-operating camera to a position at which the same object on the live view image of the non-operating camera is detected.

Components similar to those according to the first embodiment described above are designated by using like reference characters, and the description thereof is omitted or simplified. In this case, only the object detection process of the control apparatus 200 and a part of the processing that is performed by the control apparatus 200 illustrated in FIG. 6C are different, and these differences will be described.

The object detection process of the control apparatus 200 includes a process of detecting a characteristic region (for example, the face or body of a living thing such as a person or an animal, or a vehicle) and a process of recognizing a specific person or animal or vehicle, for example, that is registered in the control apparatus 200.

For example, as for a process of detecting a face, object information (reliability that represents the size and position of a person's face or certainty of the face in a photographing screen) is detected by performing the detection process on an image signal.

For example, a known facial recognition process is performed in a manner in which a skin color region is extracted from gradation color of pixels that are represented by the image data, and the face is detected by using the degree of matching of a face contour plate that is prepared in advance. For example, a method of detecting the face is to extract features of the face such as the eyes, the nose, and the mouth by using a known pattern recognition technique. The present disclosure, however, is not limited by the recognition method regarding not only the face but also any object, and any method may be used.

### Series of Processing of Control Apparatus 200 According to Second Embodiment

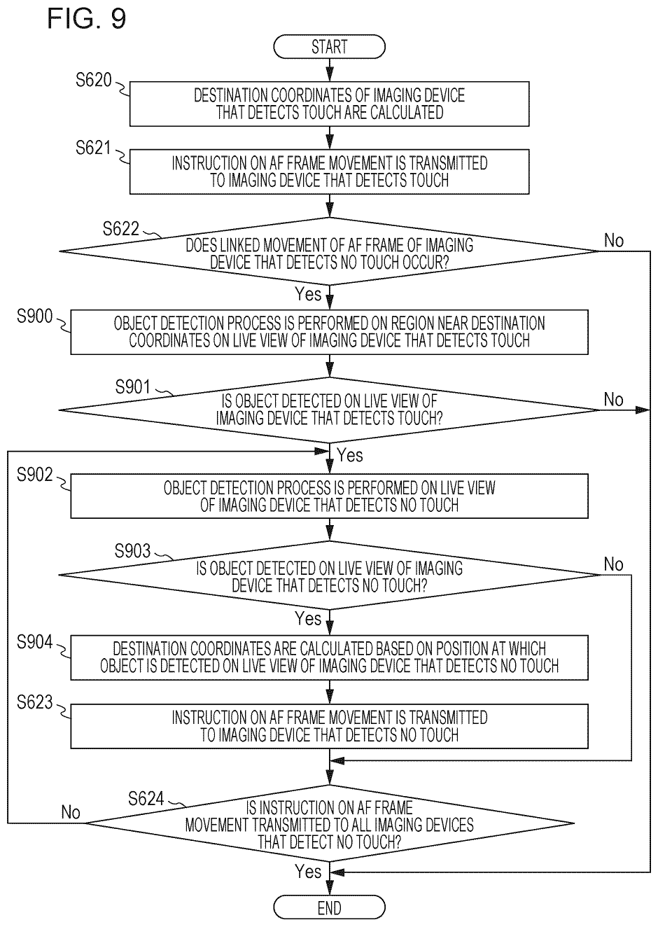

FIG. 9 illustrates a series of processing operations that are performed by the control apparatus 200 when the control apparatus 200 controls the movement of AF frames regarding the multiple digital cameras 100 according to the second embodiment. FIG. 9 corresponds to FIG. 6C described according to the first embodiment.

If it is determined at S622 that the control of AF frame linked movement is implemented, a process at S900 is performed.

At S900, the control apparatus 200 performs the object detection process on a predetermined region to be detected on the live view image that is displayed by the live view display operation member 520 of the operating camera that detects the touch operation.

In one example, the region to be detected is defined as a region having a predetermined size, the center of which is located at the destination coordinates that are calculated at S620. The predetermined size may have a fixed value that is determined by the application program that is loaded to the work memory 204 of the control apparatus 200. Alternatively, this may be a variable that is stored in the non-volatile memory 203, the work memory 204, or the recording medium 210 and that can be set by the user in any manner.

Another example of a definition of the region to be detected will be described. In this example, the live view image and the AF frame are updated in the process of displaying the multi-live view image before the object detection process at S900 is performed. The height, width, and position of the AF frame that is moved in response to the instruction on AF frame movement at S621 are used as references. Various definitions are thus used for the region to be detected, but the present disclosure is not limited thereto.

At S900, the object that is detected as a result of the object detection process is newly registered as the object to be detected in the object detection process that is subsequently performed by the control apparatus 200 for a process at S902 described later. In the case where two or more objects are detected at S900, the object nearest to the central coordinates of the region to be detected is registered. Subsequently, a process at S901 is performed.

At S901, in the case where no object is detected as a result of the object detection process at S900, the series of operations end. In the case where one or more objects are detected, the process at S902 is performed.

At S902, the object detection process is performed on the entire region of the live view image that is displayed by the live view display operation member 520 of a non-operating camera. The object that is detected in the object detection process at S902 is the same as the object that is registered at S900.

At S903, in the case where no object is detected as a result of the object detection process at S902, the process at S624 is performed. In the case where the object is detected, a process at S904 is performed.

At S904, coordinates at which the object on the live view image of the non-operating camera is detected as a result of the object detection process at S902 are calculated as the destination coordinates, and the process at S623 is performed.

At S623, the control apparatus 200 transmits the instruction on AF frame movement for instructing the AF frame of the non-operating camera to be moved to the destination coordinates that are calculated at S904, and the process at S624 is performed.

At S624, whether the control of AF frame linked movement regarding all of the non-operating cameras ends is determined. If it is determined that it ends, the series of operations ends. If it is determined that it does not end, and the control of AF frame linked movement regarding some non-operating cameras does not end, the process at S902 is performed again.

The operations described above are the series of processing operations that are performed by the control apparatus 200 when the control apparatus 200 controls the movement of the AF frames regarding the multiple digital cameras 100 according to the second embodiment. The processing described above enables the AF frame of each non-operating camera to move to a position at which the object is captured in the region of the AF frame even when the operating camera and the non-operating camera have different compositions, and the position of the object on the live view image is not similar.

According to the embodiment described above, in the case where no object is detected as a result of the object detection process on the live view image of the operating camera at S900, the AF frames of all the non-operating cameras are not moved. Alternatively, in the case where no object is detected on the live view image of the operating camera, however, the processes from S623 to S624 in FIG. 6C may be performed at S901 in combination with the first embodiment. The series of operations may end after transmission of the instruction on AF frame movement for instructing the AF frames of all the non-operating cameras to be moved to the same coordinates as the destination coordinates of the operating camera that are calculated at S620.

According to the embodiment described above, in the case where no object is detected as a result of the object detection process on the live view image of the non-operating camera at S902, the AF frame of the non-operating camera is not moved. However, as an alternative, in the case where no object is detected on the live view image of the non-operating camera at S903, processing may be performed in combination with the first embodiment. In this case, the process at S624 may be performed after transmission of the instruction on AF frame movement for instructing the AF frame of the non-operating camera to be moved to the same coordinates as the destination coordinates of the operating camera that are calculated at S620.

### Third Embodiment

According to the second embodiment described above, the control apparatus 200 performs the object detection process under the control of AF frame linked movement. The object is detected in a region near the position of the AF frame on the live view image of the operating camera. Subsequently, the AF frame of each non-operating camera is moved to the position at which the same object is detected on the live view image of the non-operating camera.

In the case where the object continues to move, however, the object leaves the region of the AF frame immediately after the AF frame is moved. For this reason, each digital camera 100 may include a detection unit and a tracking unit. Consequently, the digital camera 100 has a function of the object detection process and a function of always moving the AF frame such that the AF frame follows the object by performing a process of tracking the detected object in some cases.

In view of this, according to a third embodiment, not only the control apparatus 200 but also the digital cameras 100 may have the object detection process and move the AF frames by performing the tracking process. In the case where the operating camera starts tracking a freely selected object when the control apparatus 200 moves the AF frame of the operating camera, the non-operating cameras may track the same object.

Components similar to those according to the first embodiment and the second embodiment described above are designated by using like reference characters, and the description thereof is omitted or simplified. In this case, the object detection process and the tracking process of each digital camera 100, some of the processing operations that are performed by the digital camera 100 illustrated in FIG. 8, and some of the processing operations that are performed by the control apparatus 200 illustrated in FIG. 9 are different, and these differences will be described.

The object detection process that is performed by each digital camera 100 according to the present embodiment is the same as the object detection process that is performed by the control apparatus 200 according to the second embodiment.

That is, the object detection process of each digital camera 100 includes a process of detecting a characteristic region (for example, the face or body of a living thing such as a person or an animal, or a vehicle) and a process of recognizing a specific person or animal or vehicle, for example, that is registered in each digital camera 100. The present disclosure is not limited by the recognition method regarding any object, and any method may be used.

The tracking process that is performed by each digital camera 100 according to the present embodiment includes a process of continuously moving the AF frame such that the object that is detected in the object detection process is always captured in the region of the AF frame.

As for the AF frame selection mode that each digital camera 100 has according to the present embodiment, a tracking AF mode can be set in addition to the single point AF and the multi-point AF described above in accordance with the first embodiment and the second embodiment. The single point AF and the multi-point AF are the AF frame selection modes in which the user selects the AF frame as described above. In the tracking AF mode, however, the user selects an object from the objects that are detected in the object detection process by using a method described later. Consequently, the digital camera 100 starts the process of tracking the object that is selected by the user.

The AF frame selection mode is set in advance to be a single point AF mode or a multi-point/zone AF mode by using a photographing menu setting or a setting switch not illustrated.

Changing the AF frame selection mode into the tracking AF mode and selecting the object in the tracking AF mode are performed by the user operating the touch screen of the operation unit 105 described above. In the case where the object is detected at the position of the AF frame after movement when the AF frame is moved in response to the instruction on AF frame movement that is received from the control apparatus 200, the touch operation enables the single point AF mode or the multi-point/zone AF mode to be quickly changed into the tracking AF mode. In addition, the detected object can be tracked.

According to the present embodiment, information (tracking information) that represents whether each digital camera 100 is tracking the object, that is, whether the AF frame is continuously moved so as to follow the object, is included in the AF frame information.

### Series of Processing of Digital Camera 100 According to Third Embodiment

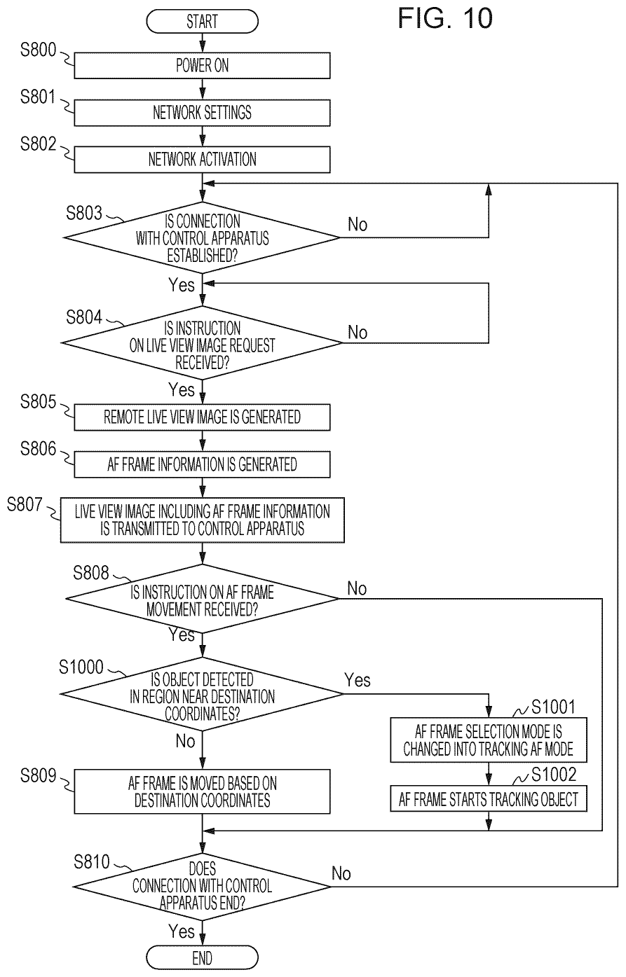

FIG. 10 illustrates a series of operations that are performed by the multiple digital cameras 100 connected to the control apparatus 200 during multi-remote photographing according to the third embodiment. Processing performed herein includes a process of displaying the live view images of the multiple digital cameras 100 on the multi-remote photographing screen. In addition, a series of operations that are performed by the digital cameras 100 when movement of the AF frames of the multiple digital cameras 100 is controlled is illustrated.

FIG. 10 corresponds to FIG. 8 described according to the first embodiment.

At S808, whether the instruction on AF frame movement is received from the control apparatus 200 is determined. If it is determined that the instruction for AF frame movement is received, a process at S1000 is performed. If it is determined that the instruction on AF frame movement is not received, the process at S810 is performed.

At S1000, the destination coordinates that are represented by the instruction for AF frame movement that is received from the control apparatus 200 at S808 are read. In the case where a distance from the destination coordinates to the object that is detected in the object detection process is shorter than a predetermined distance, it is determined that the user has chosen to track the object, and a process at S1001 is performed. If the distance is equal to or greater than the predetermined distance, it is determined that the user has chosen not to track the object and that the position of the AF frame is to be changed to the destination coordinates, and the process at S809 is performed. The predetermined distance is expressed, for example, as a fixed value that is determined by, for example, a program that is stored in the non-volatile memory 103 of each digital camera 100.

At S1001, the AF frame selection mode is changed to the tracking AF mode.

At S1002, the process of tracking the object that is selected at S1000 starts, and the process at S810 is performed. Consequently, each digital camera 100 continuously moves the AF frame such that the detected object is always captured in the region of the AF frame.

The operations described above are the series of operations that are performed by each of the multiple digital cameras 100 connected to the control apparatus 200 during multi-remote photographing according to the third embodiment.

### Series of Processing of Control Apparatus 200 According to Third Embodiment

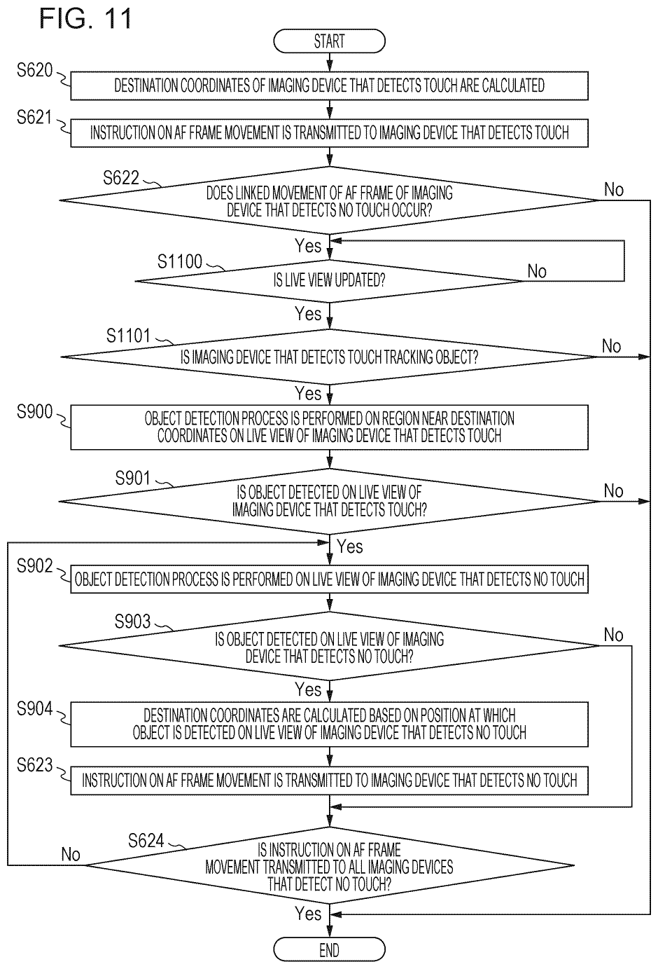

FIG. 11 illustrates a series of processing operations that are performed by the control apparatus 200 when the control apparatus 200 controls the movement of the AF frames regarding the multiple digital cameras 100 according to the third embodiment.

FIG. 11 corresponds to FIG. 9 described according to the second embodiment.

At S1100, it is determined whether the live view image and the AF frame are updated in the process of displaying the multi-live view image illustrated in FIG. 6B after the instruction on AF frame movement is transmitted to the operating camera 100 at S621 and after it is determined that AF frame linked movement is activated at S622. If it is determined that the live view image and the AF frame are updated, a process at S1101 is performed. If it is determined that the live view image and the AF frame are not updated, the process at S1100 is repeated, and whether the live view image and the AF frame are updated is checked again.

At S1101, the AF frame information is read from the additional information in the live view image that is received from the operating camera, and whether the operating camera is tracking the object is determined from the tracking information that is stored in the AF frame information. If it is determined that the object is being tracked, the process at S900 is performed. If it is determined that the object is not being tracked, the series of operations end.

At S900, the object detection process is performed on the region to be detected in the live view image of the operating camera as in the second embodiment. However, the region to be detected is defined based on information about the size and position of the AF frame for which the result of the determination at S1101 is that it is tracking the object.

The operations described above are the series of processing operations that are performed by the control apparatus 200 when the control apparatus 200 controls the movement of the AF frames regarding the multiple digital cameras 100 according to the third embodiment. The processing described above enables the AF frame of each non-operating camera to move to a position at which the object is captured in the region of the AF frame even in the case where the operating camera and the non-operating camera have different compositions, and the positions of the object on the live view images are not similar. In addition, the process of tracking the object regarding the operating camera and the non-operating cameras starts in response to the digital cameras 100 receiving the instruction on AF frame movement from the control apparatus 200, and consequently, the object can be always captured in an AF region even in the case where the object always moves.

According to the embodiment described above, in the case where the operating camera tracks nothing at S1101, the AF frames of all the non-operating cameras are not moved. Alternatively, in the case where the operating camera tracks nothing at S1101, however, the processes from S623 to S624 in FIG. 6C may be performed in combination with the first embodiment. The series of operations may end after transmission of the instruction on AF frame movement for instructing the AF frames of all the non-operating cameras to be moved to the same coordinates as the destination coordinates of the operating camera that are calculated at S620.

In the method according to the second embodiment and the third embodiment described above, all of the non-operating cameras start tracking the same object as the operating camera under the control of AF frame linked movement. However, it is possible that only one or more non-operating cameras that belong to the same group as the main camera may track the same object as the operating camera. One or more non-operating cameras that belong to a group that differs from the group to which the main camera belongs may track another object that differs from the object that is tracked by the operating camera. That is, at S902 illustrated in FIG. 9, whether the name of the group that is displayed by the name display member 512 of the operating camera is the same as the name of the group that is displayed by the name display member 512 of each non-operating camera may be determined. In the case of the same group, the same object as the object that is registered at S900 may be detected in the object detection process. In the case of different groups, another object that differs from the object that is registered at S900 may be detected.

### Modification

According to the third embodiment described above, the control apparatus 200 detects the object in a region near the position of the AF frame on the live view image of the operating camera by performing the object detection process. The instruction on AF frame movement to the position at which the same object as the object described above in the live view image of each non-operating camera is detected is transmitted, and consequently, tracking starts. However, it is possible that the control apparatus 200 may not have the object detection process function, the digital cameras 100 according to the third embodiment may have the object detection process function, and the digital cameras 100 may share the result of the object detection process with the control apparatus 200.

For example, the digital cameras 100 have detection frame information as the additional information in the live view image. The detection frame information includes information (position and size information) that represents the position and size of the object that is detected in the object detection process of the digital cameras 100 and is represented by, for example, the X-axis and Y-axis coordinates in the coordinate system of the live view image. The control apparatus 200 calculates the destination coordinates in the object detection process from the live view image of each non-operating camera at S902 in FIG. 11. Alternatively, the detection frame information is read from the additional information in the live view image of the non-operating camera, and the coordinates of a detection frame that is nearest to the position of the AF frame that is tracking the object of the operating camera calculated at S900 are calculated as the destination coordinates.

In some cases, only one or more non-operating cameras that belong to the same group as the main camera track the same object as the operating camera as described above. In these cases, at S902, whether the name of the group that is displayed by the name display member 512 of the operating camera is the same as the name of the group that is displayed by the name display member 512 of each non-operating camera may be determined. In the case of the same group, the position of the detection frame nearest to the position of the AF frame that is tracking the object of the operating camera is calculated as the destination coordinates. In the case of different groups, the position of another detection frame is calculated as the destination coordinates.

According to the embodiments ts described above, the multi-remote photographing screen 500 is divided between the main camera display member 504 and the sub-camera display member 505. The first camera control member 501 is added to the main camera display member 504, and the second and additional camera control members 502 are added to the sub-camera display member 505. The second and third camera control members 502 are displayed in a smaller size than the first camera control member 501.

However, the display form of the multi-remote photographing screen 500 of the control apparatus 200 is not limited thereto. For example, the multi-remote photographing screen 500 may not be divided between the main camera display member 504 and the sub-camera display member 505. The camera control members 501 and 502 and the live view display operation members 520 regarding all of the digital cameras 100 may be displayed so as to be arranged side-by-side in the same form.

Preferred embodiments of the present disclosure are described above, but the present disclosure is not limited to these embodiments, and various amendments and modifications can be made without departing from the spirit thereof.

### Other Embodiments

The present disclosure is provided by performing processing described below. That is, in the processing, software (a program) that fulfills the functions of the embodiments described above is distributed to a system or an apparatus via a network or various storage media, and a computer of the system or the apparatus (or a controller, a MPU, or so on) reads and runs a program code. In this case, the program, and a storage medium that stores the program provide the present disclosure.

The present disclosure is described in detail above based on the preferred embodiments thereof. The present disclosure, however, is not limited to the specific embodiments, and various embodiments are included in the present disclosure without departing from the spirit of the disclosure. The embodiments described above may be partly combined as appropriate.

Functional units according to the embodiments (and the modification) described above may or may not be implemented in individual hardware. The functions of two or more functional units may be fulfilled by common hardware. Multiple functions of a single functional unit may be fulfilled by respective pieces of hardware. Two or more functions of a single functional unit may be fulfilled by common hardware. The functional units may or may not be provided by hardware such as an ASIC, a FPGA, or a DSP. For example, the apparatus may include a processor and a memory (a storage medium) that contains a control program. The function of at least one functional unit that is included in the apparatus may be fulfilled in a manner in which the processor reads the control program from the memory and runs the control program.

The present disclosure can be provided by a process in which a program that fulfills one or more functions of the embodiments described above is distributed to a system or an apparatus via a network or a storage medium, and one or more processors of a computer of the system or the apparatus read and run the program. The present disclosure can be provided by a circuit (such as an ASIC) that fulfills one or more functions.

### First Aspect

A control apparatus remotely controls multiple imaging devices that are connected via a network and includes:
an acquisition unit configured to acquire LV images from the multiple imaging devices;
a display unit configured to display the LV images that are acquired by the acquisition unit; and
a control unit,
the control unit is configured to:
transmit movement instruction information about an AF frame for which first coordinate information corresponding to a position at which a first LV image is touched is specified to a first imaging device associated with the first LV image in a case where the first LV image that is displayed on the display unit is touched; and
transmit movement instruction information about an AF frame for which second coordinate information based on the first coordinate information is specified to a second imaging device that differs from the first imaging device.

### Second Aspect

As for the control apparatus described in First Aspect,
the second coordinate information is coordinate information that is the same as the first coordinate information.

### Third Aspect

As for the control apparatus described in First Aspect,
the second coordinate information is coordinate information that differs from the first coordinate information.

### Fourth Aspect

As for the control apparatus described in Third Aspect,
the control unit is configured to:
calculate the second coordinate information by converting the first coordinate information in a case where size information about the first LV image differs from size information about a second LV image associated with the second imaging device.

### Fifth Aspect

The control apparatus described in First Aspect further includes:
a detection unit configured to detect an object, based on the position at which the first LV image is touched, and
the control unit is configured to specify, as the first coordinate information, coordinates at which the object that is detected by the detection unit is present.

### Sixth Aspect

As for the control apparatus described in Fifth Aspect,
the detection unit is configured to:
detect the same object in a LV image of the second imaging device, based on information about an object that is detected based on the first coordinate information, and
coordinates at which the same object is present are specified as the second coordinate information.

### Seventh Aspect

As for the control apparatus described in Fifth Aspect or Sixth Aspect,
the detection unit is configured to:
detect an object that is nearest to the position at which the first LV image is touched.

### Eighth Aspect

As for the control apparatus described in any one of Fifth Aspect to Seventh Aspect,
the control unit is configured to:
transmit the movement instruction information about the AF frame for which the second coordinate information based on the first coordinate information is specified to an imaging device that belongs to the same group as the first imaging device.

### Ninth Aspect

As for the control apparatus described in any one of Fifth Aspect to Seventh Aspect,
the control unit is configured to:
transmit the movement instruction information about the AF frame for which the second coordinate information representing coordinates at which an object that differs from the object that is represented by the first coordinate information is present is specified to an imaging device that belongs to a group different from that of the first imaging device.

### Tenth Aspect

As for the control apparatus described in any one of First Aspect to Ninth Aspect,
the control unit is configured to:
transmit the movement instruction information about the AF frame for which the second coordinate information based on the first coordinate information is specified to the second imaging device that differs from the first imaging device in a case where a setting of AF frame linked movement is activated.

### Eleventh Aspect

A control method of remotely controlling multiple imaging devices that are connected via a network includes:
acquiring LV images from the multiple imaging devices,
displaying the LV images that are acquired on a display unit,
transmitting movement instruction information about an AF frame for which first coordinate information corresponding to a position at which a first LV image is touched is specified to a first imaging device associated with the first LV image in a case where the first LV image that is displayed on the display unit is touched, and
transmitting movement instruction information about an AF frame for which second coordinate information based on the first coordinate information is specified to a second imaging device that differs from the first imaging device.

### Twelfth Aspect

A program for causing a computer to function as a control apparatus that remotely controls multiple imaging devices that are connected via a network,
the control apparatus includes:
an acquisition unit configured to acquire LV images from the multiple imaging devices,
a display unit configured to display the LV images that are acquired by the acquisition unit, and a control unit, and
the control unit is configured to:
transmit movement instruction information about an AF frame for which first coordinate information corresponding to a position at which a first LV image is touched is specified to a first imaging device associated with the first LV image in a case where the first LV image that is displayed on the display unit is touched, and
transmit movement instruction information about an AF frame for which second coordinate information based on the first coordinate information is specified to a second imaging device that differs from the first imaging device.

### Thirteenth Aspect

A system includes multiple imaging devices, and a control apparatus that remotely controls the multiple imaging devices that are connected via a network,
the control apparatus includes:
an acquisition unit configured to acquire LV images from the multiple imaging devices,
a display unit configured to display the LV images that are acquired by the acquisition unit, and a control unit,
the control unit is configured to:
transmit movement instruction information about an AF frame for which first coordinate information corresponding to a position at which a first LV image is touched is specified to a first imaging device associated with the first LV image in a case where the first LV image that is displayed on the display unit is touched, and
transmit movement instruction information about an AF frame for which second coordinate information based on the first coordinate information is specified to a second imaging device that differs from the first imaging device, and the multiple imaging devices include a detection unit configured to detect an object, based on coordinate information that is included in the movement instruction information about the AF frame that is received from the control apparatus.

### Fourteenth Aspect

As for the system described in Thirteenth Aspect,
the multiple imaging devices further include:
a tracking unit configured to track the object that is detected by the detection unit.

According to the present disclosure, the control apparatus that is operated by the photographer can control the movement of the AF frames of the multiple digital cameras by being collectively operated.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-150537, filed Sep. 2, 2024, the entirety of which is incorporated herein by reference.

What is claimed is:

1. A control apparatus that remotely controls multiple imaging devices that are connected to the control apparatus via a network, the control apparatus comprising:
an acquisition unit configured to acquire live-view images from the multiple imaging devices;
a display unit configured to display the live-view images that are acquired by the acquisition unit;
an operation unit configured to receive a touch operation performed by a user;
at least one memory storing a program; and
at least one processor that, upon execution of the stored program, is configured to:
transmit movement instruction information about an autofocus frame for which first coordinate information corresponding to a position at which a first live-view image is touched is specified to a first imaging device associated with the first live-view image in a case where the first live-view image that is displayed on the display unit is touched; and
transmit movement instruction information about an autofocus frame for which second coordinate information based on the first coordinate information is specified to a second imaging device that differs from the first imaging device.

2. The control apparatus according to claim 1,
wherein the second coordinate information is coordinate information that is the same as the first coordinate information.

3. The control apparatus according to claim 1,
wherein the second coordinate information is coordinate information that differs from the first coordinate information.

4. The control apparatus according to claim 3,
wherein the at least one processor, upon execution of the stored program, is further configured to:
calculate the second coordinate information by converting the first coordinate information in a case where size information about the first live-view image differs from size information about a second live-view image associated with the second imaging device.

5. The control apparatus according to claim 1,
wherein the at least one processor, upon execution of the stored program, is further configured to:
detect an object in the first live-view image based on the position at which the first live-view image is touched; and
specify, as the first coordinate information, coordinates at which the object that is detected is present.

6. The control apparatus according to claim 5,
wherein the at least one processor, upon execution of the stored program, is further configured to:
detect the same object in a second live-view image associated with the second imaging device, based on information about an object that is detected in the second live-view image based on the first coordinate information, and
specify, as the second coordinate information, coordinates at which the same object that is detected is present.

7. The control apparatus according to claim 5,
wherein the at least one processor, upon execution of the stored program, is further configured to:
detect an object in the first live-view image that is nearest to the position at which the first live-view image is touched.

8. The control apparatus according to claim 1,
wherein the at least one processor, upon execution of the stored program, is further configured to:
transmit the movement instruction information about the autofocus frame for which the second coordinate information based on the first coordinate information is specified to an imaging device that belongs to a same group as the first imaging device.

9. The control apparatus according to claim 5,
wherein the at least one processor, upon execution of the stored program, is further configured to:
transmit the movement instruction information about the autofocus frame for which the second coordinate information representing coordinates at which an object that differs from the object detected in the first live-view image is present is specified to an imaging device that belongs to a group different from that of the first imaging device.

10. The control apparatus according to claim 1,
wherein the at least one processor, upon execution of the stored program, is further configured to:
transmit the movement instruction information about the autofocus frame for which the second coordinate information based on the first coordinate information is specified to the second imaging device that differs from the first imaging device in a case where a setting of autofocus frame linked movement is activated.

11. A control method of remotely controlling multiple imaging devices that are connected to a control apparatus via a network, the control method comprising:
acquiring live-view images from the multiple imaging devices;
displaying the live-view images that are acquired on a display unit;
receiving a touch operation performed by a user on an operation unit;
transmitting movement instruction information about an autofocus frame for which first coordinate information corresponding to a position at which a first live-view image is touched is specified to a first imaging device associated with the first live-view image in a case where the first live-view image that is displayed on the display unit is touched; and
transmitting movement instruction information about an autofocus frame for which second coordinate information based on the first coordinate information is specified to a second imaging device that differs from the first imaging device.

12. A non-transitory computer-readable storage medium which stores a program for causing a computer to execute a method, the method comprising:
acquiring live-view images from multiple imaging devices;
displaying the live-view images that are acquired on a display unit;
receiving a touch operation performed by a user on an operation unit;
transmitting movement instruction information about an autofocus frame for which first coordinate information corresponding to a position at which a first live-view image is touched is specified to a first imaging device associated with the first live-view image in a case where the first live-view image that is displayed on the display unit is touched; and
transmitting movement instruction information about an autofocus frame for which second coordinate information based on the first coordinate information is specified to a second imaging device that differs from the first imaging device.

13. A system comprising: multiple imaging devices; and a control apparatus that remotely controls the multiple imaging devices that are connected to the control apparatus via a network,
wherein the control apparatus includes:
an acquisition unit configured to acquire live-view images from the multiple imaging devices;
a display unit configured to display the live-view images that are acquired by the acquisition unit;
an operation unit configured to receive a touch operation performed by a user;
at least one memory storing a program; and
at least one processor that, upon execution of the stored program, is configured to:
transmit movement instruction information about an autofocus frame for which first coordinate information corresponding to a position at which a first live-view image is touched is specified to a first imaging device associated with the first live-view image in a case where the first live-view image that is displayed on the display unit is touched; and
transmit movement instruction information about an autofocus frame for which second coordinate information based on the first coordinate information is specified to a second imaging device that differs from the first imaging device, and
wherein the multiple imaging devices each include:
at least one device memory storing a device program; and
at least one device processor that, upon execution of the stored device program, is configured to function as a detection unit configured to detect an object based on coordinate information that is included in the movement instruction information about the autofocus frame that is received from the control apparatus.

14. The system according to claim 13,
wherein the at least one device processor of each multiple imaging device, upon execution of the stored device program, is further configured to function as a tracking unit configured to track the object that is detected by the detection unit.
